(19) United States
(12) Patent Application Publication
(10) Pub. No.: US 2017/0302563 A1
(43) Pub. Date: Oct. 19, 2017

(54) CONTENT-CENTRIC NETWORK ON-DEMAND DISTANCE VECTOR ROUTE METHOD

(71) Applicant: INSTITUTE OF ACOUSTICS,CHINESE ACADEMY OF SCIENCES, Beijing (CN)

(72) Inventors: Jinlin WANG, Beijing (CN); Weining QI, Beijing (CN); Jiali YOU, Beijing (CN); Lingfang WANG, Beijing (CN)

(73) Assignee: INSTITUTE OF ACOUSTICS,CHINESE ACADEMY OF SCIENCES, Beijing (CN)

(21) Appl. No.: 15/513,561

(22) PCT Filed: Dec. 10, 2014
(86) PCT No.: PCT/CN2014/093490

§ 371 Date: Mar. 23, 2017

(30) Foreign Application Priority Data
Sep. 23, 2014 (CN) 201410492153.2

(51) Int. Cl. H04L 12/733; H04L 12/721; H04L 12/751

(52) U.S. Cl. CPC H04L 45/122; H04L 45/02; H04L 45/26

(57) ABSTRACT

The present invention relates to a content-centric network on-demand distance vector route method, comprising: a request source node of a required request route broadcasts a route request packet CCN_RREQ to other nodes in a network, and starts a route discovery process; after a target node receives the route request packet CCN_RREQ, replying with a route reply packet CCN_RREP; after the request source node receives the route reply packet CCN_RREP returned by the target node, establishing a path between the request source node and the target node according to the content of the route reply packet CCN_RREP.

### CROSS REFERENCE TO RELATED APPLICATIONS

This application is the national phase entry of International Application No. PCT/CN2014/093490, filed on Dec. 10, 2014, which is based upon and claims priority to Chinese Patent Application No. 201410492153.2 filed on Sep. 23, 2014, the entire contents of which are incorporated herein by reference.

### TECHNICAL FIELD

The present invention relates to a network routing method, and in particular to a content-centric network on-demand distance vector route method.

### BACKGROUND OF THE INVENTION

A content-centric network (CCN) represents a network :structure with content or information as the center. The CCN takes content as the center, and does not concern a provider of the content, but concerns the content itself only. The CCN better satisfies requirements for information content consumption by naming of content and routing based on content naming. The CCN discards a traditional protocol stack structure with IP as thin waist, and adopts a protocol stack structure with a content name as the core, which is compatible with different transmission manners (IP, Ethernet, P2P, etc.) downwards, and supports different service applications (content distributing, streaming media, voice of internet phone, etc.) upwards. This design idea with content as the center causes the CCN to support congenitally a movement of the content and a user in a network, provide a trustable certification of information, and be capable of improving greatly the broadcasting efficiency of the information in the network, and have incomparable superiority in architecture over the traditional IP network.

In 2012, in order to be capable of updating automatically an FIB table according to a change of network topology when deployed on a CCN testbed, the NDN project group proposes an OSPFN routing method on the basis of OSPF. However, the OSPFN routing method is not optimized for the defects of the large number of route table items and the slow route lookup.

Thereafter, the NDN project group proposes the named-data link state routing method NLSR. The NLSR protocol further describes a method for naming a router and a link based on a URL, determines a format of an information packet for link state of interaction between neighboring nodes, and describes related multi-path computation and route failure recovery mechanism. However the NLSR does not solve the problem that the route table items are difficult to be aggregated when routing is performed in CCN.

In sum, the existing content-centric network performs a route query based on data naming, which itself has a contradiction between a limitless naming space and limited route table items. It is a problem to be solved that how to compress route table items by suitable route packets and decreasing route entries as much as possible.

### SUMMARY OF THE INVENTION

An objective of the present invention lies in that in order to overcome defects existing in the routing method of the content-centric network in the prior art, the present invention provides an on-demand distance vector route method.

In order to achieve the above described objective, the present invention provides a content-centric network on-demand distance vector route method comprising:

step 1), broadcasting, by a request source node that needs to request a route a route request packet CCN_RREQ to other nodes in a network to start a route discovery process, wherein the route request packet CCN_RREQ is carried in an interest packet of the content-centric network, and comprises at least the following information: a hash value of a requested content, an address of the request source node and a sequence number of the request source node;

step 2), replying, by a target node after receiving the route request packet CCN_RREQ, with a route reply packet CCN_RREP wherein the route reply packet CCN_RREP is carried in a data packet of the content-centric network, and comprises at least the following information: a hash value of the requested content, an address of a content provider and a sequence number of the content provider; and

step 3), establishing, by the request source node after receiving the route reply packet CCN_RREP returned by the target node, a path between the request source node and the target node according to content contained in the packet.

The above-described technical solution further comprises:

step 4) deleting an invalid path with a route error packet CCN_RRER when a node is invalid or a route is invalid due to an update of a cache, wherein the route error packet CCN_RRER comprises at least: an unreachable requested content, a number of entries of the unreachable requested content, an identification of an unreachable content provider and a sequence number of the unreachable content provider.

In the above-described technical solution, the step 2) comprises:

step 201), receiving, by a node, the route request packet CCN_RREQ:

step 202), checking, by the node, whether the route request packet CCN_RREQ is transmitted by the present node itself, that is, whether the request source node in the route request packet CCN_RREQ is the present node; if yes, performing the next step, otherwise turning to step 204);

step 203), discarding the route request packet CCN_RREQ, and ending operations;

step 204), checking, by the node, whether the received route request packet CCN_RREQ has been received previously: if yes, performing the step 203), otherwise performing the next step;

step 205), checking, by the node, whether the content requested by the route request packet CCN_RREQ exists in its own cache table; if yes, the node being the content provider, and performing the next step, otherwise turning to step 207);

step 206), replying with the route reply packet CCN_RREP to the node that transmits the route request packet CCN_RREQ:

step 207), reviewing, by the node, whether an entry corresponding to a valid path of the content requested by the route request packet CCN_RREQ exists in a route table; if yes, performing step 206), otherwise performing the next step; and

step 208), caching and broadcasting the route request packet CCN_RREQ,

In the above-described technical solution, the step 3) comprises:

step 301), receiving, by a node, the route reply packet CCN_RREP;

step 302), judging, by the node, whether a valid route from the present node to a target hash is saved in its own route table; if yes, performing the next step, otherwise turning to step 307); wherein the target hash refers to the hash value of the content contained in the route reply packet CCN_RREP, and the valid route refers to a route that a lifetime of the route entry does not expire;

step 303), judging, by the node, whether a valid route to a content target in the route reply packet CCN_RREP of the same content provider exists in its own route table; if yes, performing the next step, otherwise turning to step 306);

step 304), comparing a sequence number of a destination node of a respective route entry in the route table and a sequence number of a destination node in the route reply packet CCN-RREP; if the sequence number of the destination node in the route reply packet CCN_RREP is more recent, turning to step 307), otherwise performing the next step:

step 305) performing step 307) if the sequence number of the destination node in the route reply packet CCN_RREP is the same as the sequence number of the destination node of the respective route entry in the route table, but has a less number of hops; otherwise turning to step 308);

step 306), judging whether a multi-path table item of the content in the route table is already saturated; if yes, turning to step 308), otherwise performing the next step;

step 307), adding or updating the respective route entry, forwarding the route reply packet CCN_RREP to a previous hop node according to an Intesrst table of the CNN, and ending operations; and

step 308), discarding the route reply packet CCN_RREP, and ending operations.

In the above-described technical solution, the step 4) comprises:

step 401), detecting, by a previous hop node of the destination node in the path, whether the route is invalid; if the node when forwarding the interest packet finds that a distance from itself to the content provider is 1, the node is the previous hop node of the destination node, and the node starts a timeout timer when sending the interest packet;

step 402), judging, by the node, that the path is already invalid, if the timeout tinier has already expired, but the previous hop node of the destination node does not receive the data packet sent by a corresponding content provider as expected;

step 403), marking, by the previous hop node of the destination node, a corresponding path as invalid, and sending the CCN_RRER packet to its pervious hop node in the corresponding path to notify the previous hop node that this path is already invalid; and

step 404), reviewing first, by the node after receiving the CCN_RRER packet, whether a valid path of the corresponding content provider exists; if yes, marking the corresponding path as invalid, and sending the CCN_RRER packet to the previous hop node in the corresponding path to notify the node that the path is already invalid; if no, discarding the CCN_RRER packet.

The advantages of the present invention are in that:

1. the method according to the present invention decreases route table items, improves the efficiency of route querying, and reduces effectively the routing cost, by establishing the route on-demand;

2. the method deletes the invalid route timely by detecting the invalid route and performing route repair.

### BRIEF DESCRIPTION OF THE DRAWINGS

FIG. 1 is a schematic diagram of a data structure of a route request packet CCN_RREQ;

FIG. 2 is a schematic diagram of a data structure of a route reply packet CCN_RREP;

FIG. 3 is a schematic diagram of a data structure of a route error packet CCN_RRER;

FIG. 4 is a flow diagram for a target node replying with the route reply packet CCN_RREP in a method according to the present invention;

FIG. 5 is a flow diagram for establishing a path between a request source and a target node in a method according to the present invention.

### DETAILED DESCRIPTION OF THE INVENTION

Now the present invention is further described in conjunction with the accompanying drawings.

A content-centric network on-demand distance vector route method according to the present invention mainly adopts three route control messages, which are respectively: a route request packet CCN_RREQ a route reply packet CCN_RREP and a route error packet CCN_RRER, wherein the route request packet CCN_RREQ may be carried in an interest packet of the content-centric network, and include the following information: a hash valve of a requested content, an address of a requesting source node, a sequence number of the requesting source node or the like; the route reply packet CCN_RREP may be carried in a data packet of the content-centric network, and include the following information: a hash value of the requested content, an address of a content provider, a sequence number of the content provider and the like.

The above described three route control messages play an important role in the route method according to the present invention. Data structures of these packets are explained further below.

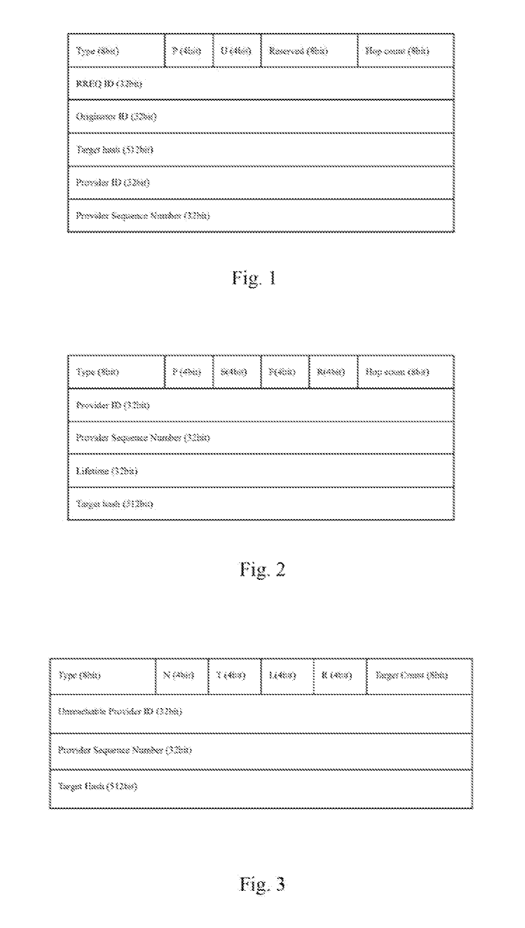

FIG. 1 is a schematic diagram of a data structure of a route request packet CCN_RREQ, wherein Type refers to a type of the packet, a value thereof is set as 1. P is a flag bit that only a content provider may reply with the CCN-RREQ packet, meaning that only the content provider may respond to this CCN-RREQ packet and an intermediate node which has a route but has no content cannot respond to this CCN-RREQ packet. U is a sequence number-unknowable flag bit, which means that the sequence number of the content provider is unknown for the present node. Reserved is a reserved bit, the value thereof is 0 currently. Hop Count represents the number of hops from an originating node for the CCN-RREQ packet to a node processing the packet. RREQ ID is an ID of the CCN-RREQ packet, and generated by the node generating the CCN packet, and used together with a subsequent Originator ID. Originator ID is an ID of a node generating the CCN packet. Target hash is a hash value of the requested content. Provider ID is an ID of a content provider known by the present node. Provider Sequence Number is a serial number of the above described Provider ID. The last two items may be null if there is no known content provider.

FIG. 2 is a schematic diagram of a data structure of a route reply packet CCN_RREP, wherein Type refers to a type of the packet, a value thereof is set as 2. P is a content provider flag bit, which means that the CCN-RREP packet is transmitted by the content provider. S, F and R are reserved bits, the values thereof are 0 currently. Hop Count represents the number of hops from a node generating the CCN-RREP packet to a node processing the packet. Provider ID is an ID of the node generating the CCN-RREP packet. Provider Sequence Number is a sequence number of a generating node associated with the route. Lifetime is a lifetime of a route in ms. Target hash is a hash value of a required content.

FIG. 3 is a schematic diagram of a data structure of a route error packet CCN_RRER, wherein. Type is a type of the packet, the value thereof is set as 2. N is a “don't delete” flag bit. T is a target hash-unreachable flag bit. L is a link interruption flag bit. R is a reserved bit, the value thereof is 0 currently. Target Count is the number of entries of unreachable hash values in the message. Unreachable Provider ID is an ID of an unreachable content provider. Unreachable Provider Sequence number is a sequence number associated with the above-described content provider. Target Hash is a hash value of unreachable content.

Specific implementation steps of the method according to the present invention are explained below in detail.

Step 1), broadcasting, by a node when needing to request a route (this node is also referred to as a request source), a route request packet CCN_RREQ to other nodes in a network to start a route discovery process;

step 2), replying, by a target node after receiving the route request packet CCN_RREQ, with a route reply packet CCN_RREP;

step 3), establishing, by the request source after receiving the route reply packet CCN_RREP returned by the target node, a path between the request source and the target node according to content contained in the packet.

In step 1), the circumstances that the node needs to request a route comprise: when a node needs a route to a hash value of a certain content, and no corresponding valid route entries exists in a route table of the node.

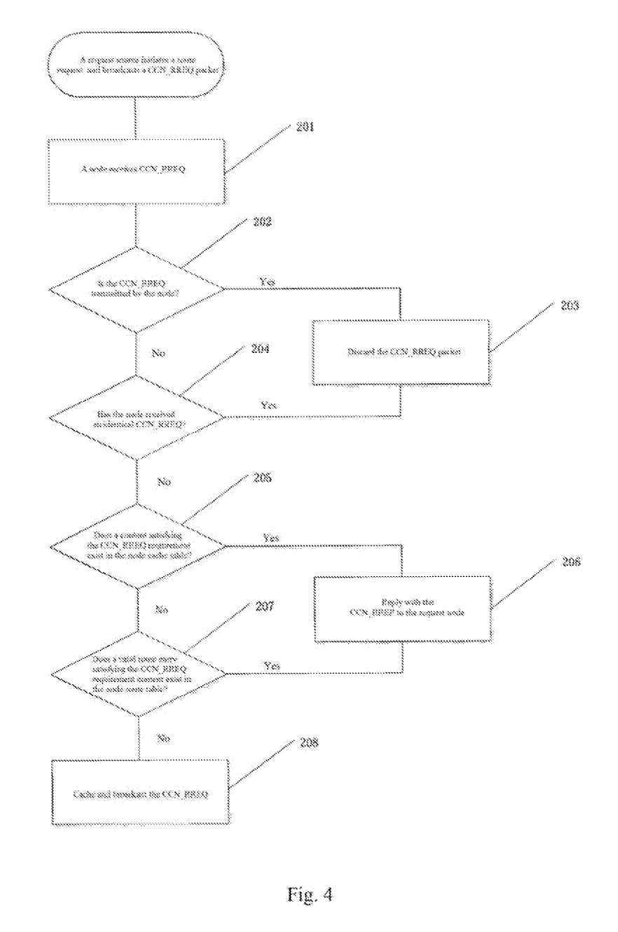

Referring to FIG. 4, the step 2) further comprises:

step 201), receiving, by a node, the route request packet CCN_RREQ:

step 202), checking, by the node, whether the route request packet CCN_RREQ is transmitted by the present node on its own, that is, whether a request source node in the route request packet CCN_RREQ is the present node; if yes, performing the next step, otherwise turning to step 204);

step 203), discarding the route request packet CCN_RREQ, ending operations;

step 204), checking, by the node, whether the received route request packet CCN_RREQ has been received previously; if yes, performing step 203), otherwise performing the next step;

step 205), checking, by the node, whether the content requested by the route request packet CCN_RREQ (i.e. content corresponding to the hash value of the requested content in the route request packet CCN_RREQ) exists in its own cache table: if yes, the node being the content provider, and performing the next step, otherwise turning to step 207);

step 206), replying with the route reply packet CCN_RREP to the node that transmits the route request packet CCN_RREQ;

step 207), reviewing, by the node, whether an entry corresponding to a valid path of the content requested by the route request packet CCN_RREQ exists in the route table; if yes, performing step 206), otherwise performing the next step;

step 208), caching and broadcasting the route request packet CCN_RREQ; the step of caching the route request packet CCN_RREQ can prevent the identical CCN_RREQ packet from being received by the node later, and the step of broadcasting the route request packet CCN_RREQ aids other nodes in the network to receive the route request packet CCN_RREQ.

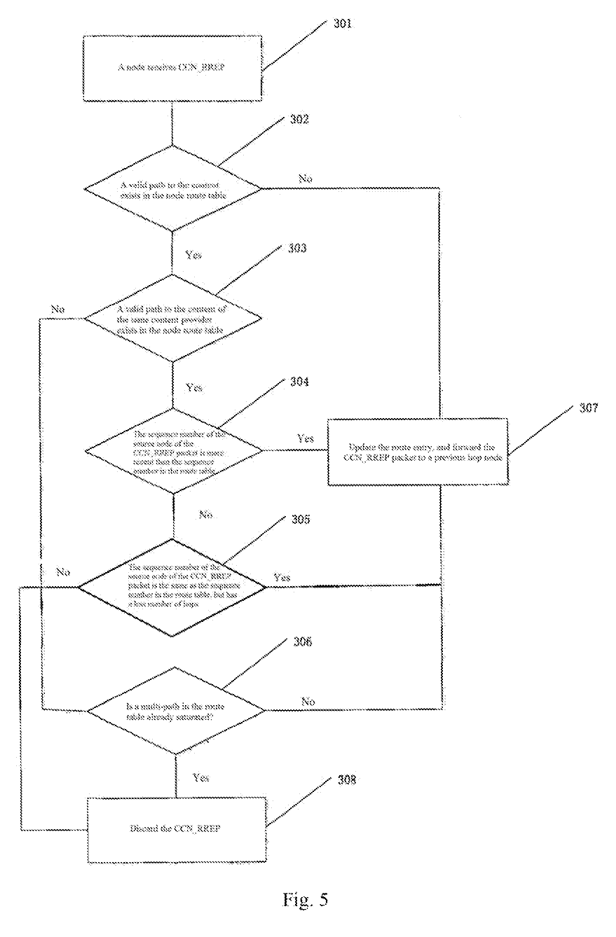

Referring to FIG. 5, the step 3) further comprises;

step 301), receiving, by a node, the route reply packet CCN_RREP; the node may be an arbitrary node between a destination node to the request source node;

step 302), judging, by the node, whether a valid route from the present node to a target hash is saved in its own route table; if yes, performing the next step, otherwise turning to step 307); wherein the target hash refers to the hash value of the content contained in the route reply packet CCN_RREP; the valid route refers to the route that a lifetime of the route entry does not expire;

step 303), judging, by the node, whether a valid route to a content target in the route reply packet CCN_RREP of the same content provider exists in its own route table; if yes, performing the next step, otherwise turning to step 306);

step 304), comparing a sequence number of the destination node of a respective route entry in the route table and a sequence number of the destination node in the route reply packet CCN_RREP, if the sequence number of the destination node in the route reply packet CCN_RREP is more recent, turning to step 307), otherwise performing the next step;

step 305), per step 307) if the sequence number of the destination node in the route reply packet CCN_RREP is the same as the sequence number of the destination node of the respective route entry in the route table but has a less number of hops; otherwise turning to step 308);

step 306), judging whether a multi-path table item of the content in the route table is statured; if yes, turning to step 308), otherwise performing the next step;

step 307), adding or updating a respective route entry, forwarding the route reply packet CN_RREP to the previous hop node according to an Intesrst table of CCN, and ending operations;

step 308), discarding the route reply packet CCN_RREP, and ending operations.

As an optional implementation, the method according to the present invention further comprises:

step 4), deleting an invalid path with a route error packet CCN_RRER when the node is invalid or the route is invalid due to the update of a cache.

This step specifically comprises:

step 401), detecting, by a previous hop node of the destination node in the path, whether the route is invalid; if a node when forwarding an interest packet finds that the distance from itself to the content provider is 1, the node is the previous hop node of the destination node, and the node starts a time-out timer when sending the interest packet;

step 402), judging, by the node, that this path is already invalid if the time-out timer has already expires and the previous hop node of the destination node has not received a data packet sent by a corresponding content provider as expected;

step 403), marking, by the previous hop node of the destination node, a corresponding path as invalid, and sending the CCN_RRER packet to its previous node in the corresponding path to notify the previous hop node that this path is already invalid;

step 404), reviewing first, by the node after receiving the CCN_RRER packet, whether a valid path of the corresponding content provider exists; if yes, marking the corresponding path as invalid and sending the CCN_RRER packet to the previous hop node in the corresponding path to notify the node that this path is already invalid; if no, discarding the CCN_RRER packet.

Finally, it should be noted that the aforementioned embodiments are only used for illustrating, rather than limiting the technical solution of the present invention. Although the present invention has been described in detail with reference to the embodiments, those skilled in the art should understand that modifications or equivalent substitutions can be made to the technical solution of the present invention without departing from the scope and spirit of the technical solution of the present invention, and thereby should all be covered by the scope of the claims of the present invention.

1. A content-centric network on-demand distance vector route method, comprising:
step 1), broadcasting, by a request source node that needs to request a route, a route request packet CCN_RREQ to other nodes in a network to start a route discovery process, wherein the route request packet CCN_RREQ is carried in an interest packet of the content-centric network, and comprises at least the following information: a hash value of a requested content, an address of the request source node and a sequence number of the request source node;
step 2), replying, by a target node after receiving the route request packet CCN_RREQ, with a route reply packet CCN_RREP, wherein the route reply packet CCN_RREP is carried in a data packet of the content-centric network, and comprises at least the following information: the hash value of the requested content, an address of a content provider and a sequence number of the content provider; and
step 3), establishing, by the request source node after receiving the route reply packet CCN_RREP returned by the target node, a path between the request source node and the target node according to a content contained in the route reply packet CCN_RREP.

2. The content-centric network on-demand distance vector route method of claim 1, further comprising:
step 4) deleting an invalid path with a route error packet CCN_RRER when a node is invalid or a route is invalid due to an update of a cache, wherein the route error packet CCN_RRER comprises at least: an unreachable requested content, a number of entries of the unreachable requested content, an identification of an unreachable content provider and a sequence number of the unreachable content provider.

3. The content-centric network on-demand distance vector route method of claim 1, wherein the step 2) comprises:
step 201), receiving, by a node, the route request packet CCN_RREQ;
step 202), checking, by the node, whether the route request packet CCN_RREQ is transmitted by the node itself, that is, whether the request source node in the route request packet CCN_RREQ is the node; if yes, performing the next step, otherwise turning to step 204);
step 203), discarding the route request packet CCN_RREQ, and ending operations;
step 204), checking, by the node, whether a received route request packet CCN_RREQ has been received previously; if yes, performing the step 203), otherwise per the next step;
step 205), checking, by the node, whether a content requested by the route request packet CCN_RREQ exists in its own cache table; if yes, the node being the content provider, and performing the next step, otherwise turning to step 207);
step 206), replying with the route reply packet CCN_RREP to the node that transmits the route request packet CCN_RREQ;
step 207), reviewing, by the node, whether an entry corresponding to a valid path of the content requested by the route request packet CCN_RREQ exists in a route table; if yes, performing the step 206), otherwise performing the next step; and
step 208), caching and broadcasting the route request packet CCN_RREQ.

4. The content-centric network on-demand distance vector route method of claim l, wherein the step 3) comprises:
step 301), receiving, by a node, the route reply packet CCN_RREP;
step 302), judging, by the node, whether a valid route from the node to a target hash is saved in its own route table; if yes, performing the next step, otherwise turning to step 307); wherein the target hash refers to the hash value of the content contained in the route reply packet CCN_RREP, and the valid route refers to a route that a lifetime of a route entry does not expire;
step 303), judging, by the node, whether the valid route to a content target in the route reply packet CCN_RREP of a same content provider exists in its own route table; if yes, performing the next step, otherwise turning to step 306);
step 304), comparing a sequence number of a destination node of a respective route entry in a route table and the sequence number of the destination node in the route reply packet CCN-RREP; if the sequence number of the destination node in the route reply packet CCN_RREP is more recent, turning to step 307), otherwise performing the next step;
step 305) performing step 307) if the sequence number of the destination node in the route reply packet CCN_RREP is the same as the sequence number of the destination node of the respective route entry in the route table, but has a less number of hops; otherwise turning to step 308);
step 306), judging whether a multi-path table item of a content in the route table is already saturated; if yes, turning to step 308), otherwise performing the next step;
step 307), adding or updating the respective route entry, forwarding the route reply packet CCN_RREP to a previous hop node according to an hate rest table of CNN, and ending operations; and
step 308), discarding the route reply packet CCN_RREP, and ending the operations.

5. The content-centric network on-demand distance vector route method of claim 2, wherein the step 4) comprises:
step 401), detecting, by a previous hop node of a destination node in a path, whether the route is invalid; if the node when forwarding the interest packet finds that a distance from itself to the content provider is 1, the node is the previous hop node of the destination node, and the node starts a timeout timer when sending the interest packet;
step 402), judging, by the node, that the path is already invalid, if the timeout timer has already expired, but the previous hop node of the destination node does not receive the data packet sent by a corresponding content provider as expected;
step 403), marking, by the previous hop node of the destination node, a corresponding path as invalid, and sending the route error packet CCN_RRER to its pervious hop node in the corresponding path to notify the previous hop node that the path is already invalid; and
step 404), reviewing first, by the node after receiving the route error packet CCN_RRER, whether a valid path of the corresponding content provider exists; if yes, marking the corresponding path as invalid, and sending the route error packet CCN_RRER to the previous hop node in the corresponding path to notify the node that the path is already invalid; if no, discarding the route error packet CCN_RRER.

6. The content-centric network on-demand distance vector route method of claim 2, wherein the step 2) comprises:
step 201), receiving, by a node, the route request packet CCN_RREQ;
step 202), checking, by the node, whether the route request packet CCN_RREQ is transmitted by the node itself, that is, whether a request source node in the route request packet CCN_RREQ is the node; if yes, performing the next step, otherwise turning to step 204);
step 203), discarding the route request packet CCN_RREQ, and ending operations;
step 204), checking, by the node, whether a received route request packet CCN_RREQ has been received previously; if yes, performing the step 203), otherwise performing the next step;
step 205), checking, by the node, whether a content requested by the route request packet CCN_RREQ exists in its own cache table; if yes, the node being the content provider, and performing the next step, otherwise turning to step 207);
step 206), replying with the route reply packet CCN_RREP to the node that transmits the route request packet CCN_RREQ;
step 207), reviewing, by the node, whether an entry corresponding to a valid path of the content requested by the route request packet CCN_RREQ exists in a route table; if yes, performing the step 206), otherwise performing the next step; and
step 208), caching and broadcasting the route request packet CCN_RREQ.

7. The content-centric network on-demand distance vector route method of claim 2, wherein the step 3) comprises:
step 301), receiving, by a node, the route reply packet CCN_RREP:
step 302), judging, by the node, whether a valid route from the node to a target hash is saved in its own route table; if yes, performing the next step, otherwise turning to step 307); wherein the target hash refers to the hash value of a content contained in the route reply packet CCN_RREP, and the valid route refers to a route that a lifetime of a route entry does not expire;
step 303), judging, by the node, whether the valid route to a content target in the route reply packet CCN_RREP of a same content provider exists in its own route table; if yes, performing the next step, otherwise turning to step 306);
step 304), comparing the sequence number of a destination node of a respective route entry in the route table and the sequence number of the destination node in the route reply packet CCN-RREP; if the sequence number of the destination node in the route reply packet CCN_RREP is more recent, turning to step 307), otherwise performing the next step;
step 305) performing step 307) if the sequence number of the destination node in the route reply packet CCN_RREP is the same as the sequence number of the destination node of the respective route entry in the route table, but has a less number of hops; otherwise turning to step 308);
step 306), judging whether a multi-path table item of a content in the route table is already saturated; if yes, turning to step 308), otherwise performing the next step;
step 307), adding or updating the respective route entry, forwarding the route reply packet CCN_RREP to a previous hop node according to an Intesrst table of CNN, and ending operations; and
step 308), discarding the route reply packet CCN_RREP, and ending the operations.
